(19) United States
(12) Patent Application Publication
(10) Pub. No.: US 2003/0149634 A1
(43) Pub. Date: Aug. 7, 2003

(54) System for and method of computer controlled media buying program

(76) Inventor: Phillip Hyun, Los Angeles, CA (US)

Correspondence Address: FULBRIGHT & JAWORSKI L.L.P., 801 Pennsylvania Avenue, N.W., Washington, DC, 20004-2615, US

(21) Appl. No.: 10/066,794

(22) Filed: Feb. 6, 2002

(51) Int. Cl. G06F 17/60

(52) U.S. Cl. 705/26

(57) ABSTRACT

The present invention includes a system and method for a computer automated and directed approach to coordinating, planning, purchasing and overseeing the purchase of media advertising campaigns. A media personnel interacts with the system which tracks and coordinates the media advertising campaign through stages. Once the media director initiates the campaign, the system and method determines the necessary step and generates a mobile agent to complete the next step in the process. Once the next step is completed, the present invention continues generating mobile agents to complete stages until the campaign is completed.

### BACKGROUND

The CONSILIENT™ process collaboration aids interactive business processes between enterprises. The CONSILIENT platform creates portable, interactive process agents called TASKLET™ containers which are mobile, self contained intelligent agents used to exchange data between entities. These TASKLETS support the interactive discovery, evolution, and execution of business processes between enterprises. The CONSILIENT software automatically tracks process flows within organizations and across enterprises allowing an insight into the status of any process and allowing the identification and correction for bottlenecks within the process.

Today, the process of planning, initiating, implementing, overseeing, and tracking a media advertising campaign is a complex, time consuming, task. This task can generally be broken up into six stages consisting of: profiling, planning, placement, airing, confirmation, and reconciliation.

During the profile stage, a job order or high level description of the desired media advertising campaign is created, reviewed by the client, and is accepted by the client when the client signs and returns a buy authorization form to the media buying agency. Typically a job order is created in response to a client's inquiry concerning the media buying agency's ability and ideas in implementing a new ad campaign. The new ad campaign may contain new or existing concepts and generally promotes one or more products of the client. In response to the client's inquiry, the media buying agency generates a job order which outlines, at a top level, a proposed media campaign. The media buying agency then sends that job order to the client for review. Upon receipt of the job order from the media buying agency, the client may suggest changes to the job order or may accept the job order as proposed. If the client requests changes in the proposed job order, several iterations are possible until the client is satisfied with the proposed job order.

Once the client has accepted the proposed job order, the client returns a given buy authorization form which authorizes the media buying agency to go forward with the proposed job order. Within the media buying agency, the proposed job order and buy authorization form are used to approve the job, log the job into the media buying agency's database and assign the job to an individual employee of the media buying agency. Typically, a media director media planner or media planner, is assigned to implement the media campaign. The assigned media director analyzes the client's needs, the proposed job order and assembles a group of possible media companies which can fulfill and satisfy the client's needs. A media director may also use existing research from similar media campaigns or may use additional research from a third party software and data systems. Once the media director incorporates the analysis of the research data into a proposed campaign the profiling stage of the process is completed.

Stage 2, the planning stage, defines where the ads for the campaigns should be placed including a proposed division of advertising between various demographic audiences and media including, for example, print, broadcasting, direct mail, etc., and their respective subcategories. The planning stage of the process includes information gathering, proposal creation, and finalizing the contract. Using the updated proposed job order the media buyer sends inquiries to potential media vendors concerning availability, price, current ratings, past experience with similar ad campaigns, or any other factor which may be considered in deciding specific venues for the ad campaign. Once this information is received by the media director, the media director uses this information to decide on specific vehicles/vendors which will be used to achieve the client's objectives.

The media buyer continues interfacing and negotiating with the media vendors until the media director is able to prepare a campaign proposal which is ultimately presented to the client. The campaign proposal consolidates each of the proposed media vendors to arrive at a single report in which the ad campaign is presented to the client. The campaign proposal includes the number of placements to specific vehicles, the time slots, the anticipated effectiveness of the advertisements, and other information used by the client to review, modify, and ultimately accept a campaign proposal.

The initial campaign proposal is reviewed and, as appropriate, modified through interaction between the account executive and the client during the proposal creation phase of the planning stage of the overall process. At the completion of the proposal creation phase a finalized campaign proposal exists. In the finalized contract phase, the finalized campaign proposal is sent to the client where it is reviewed, checked to ensure that the finalized campaign proposal meets the goals and objectives of the ad campaign and is ultimately accepted. Once the client returns the accepted final campaign proposal, Stage 2 of the planning stage is completed.

In Stage 3, the media buyer uses its authority granted through the accepted final campaign proposal to confirm and book orders with the specific media vendors selected during Stage 2, the planning stage. Typically, the confirmation and book order stage commits the media buyer and the client to a total dollar amount and a number of ads on specific vehicles or with specific media vendors. While specific time slots may be identified by the media vendor, exact times are not included at this stage of the process. Only once the media vendor receives a binding confirm and book order from the media buying agency does it take steps to ensure the client receives the respective placement slots.

The ad campaign typically begins with a flight start date, or the first day that the client's ad runs on a vendor's media. Prior to the flight start date the media buying agency ensures that the correct creative has been received by each of the vendors. Additionally before the flight start date, the media director ensures agreed to business terms have been satisfied which allows the client's creative to be run on or in the vendor's medium. At this point a pre-spot schedule is typically generated by the specified media vendor which indicates which specific spots will be used to advertise the client's product. Once the media buying agency receives the pre-spot schedule, negotiations occur between the media director, or buyer and the media vendor to ensure the pre-spot schedule matches the proposal. Discrepancies are resolved in consultation with the client.

Once the vendor and the media buying agency have agreed, a finalized pre-spot schedule is generated. The media buying agency produces a schedule for the client for final approval. At this point the vendor places the ads into the appropriate broadcast or media rotation. Note that the variability of live events and complexities of scheduling demands flexibility by both the media buying agency and the client. Once the pre-spot schedule is finalized Stage 3, placement, is completed.

During this stage the vendor determines the specific time slots, a mechanical specification form is sent from the vendor sales representative to the media director. This form may be sent via facsimile. The mechanical specification form is used to notify the media director of the specific details of the “creative” e.g., a produced recording for a radio spot, or a pre-recorded commercial for a TV spot, etc. The media director will transmit the mechanical specification form, or portions thereof, to the client. After the client receives the mechanical specification form, the client supplies the specific advertising “creative” to the vendor either directly or through the media director or account executive. At this point the agency may remit advance payment for the campaign, if previously agreed to, to the vendor.

In Stage 4, the creatives supplied by the client are aired on the vendor's media in accordance with the finalized pre-spot schedule. Variations may occur due to live events or complexities of scheduling as previously discussed. Also variations may occur due to vendor preemption.

The pre-spot schedule begins with a flight start date and ends with a flight end date. The flight end date is the last date the client's creative is scheduled to be aired on the vendor's media. Periodically (monthly), the vendor sends the media buying agency invoices or affidavits for the remaining balance and typically sends air check tapes and/or the media which show that the client's creative was actually aired at the appropriate times. The media buying agency reviews the air check tapes or media with the finalized pre-spot schedule. The vendor also sends an affidavit to the media buying agency which indicates and documents the actual air time or placement of the client's spots. The media buying agency then reviews the post-spot schedule and works with the vendor to identify differences between the post-spot schedule and the finalized pre-spot schedule. Stage 5, also know as the confirmation stage of the overall process includes the steps of analyze invoices, review air check tapes, and analyze affidavits. The air check tapes may also be sent to the client for review.

The final stage of the overall process is Stage 6 entitled reconciliation. During the reconciliation stage, discrepancies between the post-spot schedule and the finalized pre-spot schedule are resolved and the appropriate action is taken. Normally the media director or buyer and the media vendor resolves discrepancies between the pre and post-logs and negotiate an agreement as to how any discrepancies should be resolved between the parties. The air check tapes or media and the post-log are sent to the client for review. Once the client has reviewed the air check tapes and the post-log they are expected to pay the media director's invoice according to the pre-arranged terms as amended. The agreement between the media director or buyer and the media vendor to resolve discrepancies between the post and the pre-log may require an adjustment to the pre-arranged terms of the final payment. Upon agreement with the client, the agency may make final payment to the vendors. Once final payment is completed, a post analysis report is prepared by the media director and furnished to the client to help the client gauge the efficacy of the campaign and to guide future advertising efforts by the client. The acceptance of the post analysis report by the client from the media buying agency completes the last stage of the overall process.

### SUMMARY OF THE INVENTION

The present invention includes a system and method of buying media resources for an advertising campaign including a number of identifiable campaign steps. These steps begin with the generation of a first mobile agent with a media availability query and the transmission of that agent to one or more potential vendors. The potential vendor(s) then return the first mobile agent with media availability. The returned first mobile agent is processed and the information contained therein is used to create a media buy confirmation that is included in a second mobile agent representing the media buy confirmation. The second mobile agent is transmitted to the vendor.

In another embodiment, the present invention also includes a computer system configured to perform the steps of (1) transmitting a first mobile agent with a media availability query to a potential vendor; (2) receiving, via the first mobile agent, media availability from the potential vendor; (3) processing the first mobile agent to create a media buy confirmation and, in response, (4) creating a second mobile agent representing the media buy confirmation. The computer system is also configured to transmit the second mobile agent representing the media buy confirmation to the potential vendor.

In another embodiment, the present invention includes a computer program contained on a computer readable media configured to perform the steps of: (1) transmitting a first mobile agent with a media availability query to a potential vendor; (2) receiving, via the first mobile agent, media availability from the potential vendor; (3) processing the first mobile agent to create a media buy confirmation and, in response; (4) creating a second mobile agent representing said media buy confirmation; and (5) transmitting the second mobile agent representing the media buy confirmation to the potential vendor.

### BRIEF DESCRIPTION OF THE DRAWINGS

FIG. 1 is one embodiment of a system implementing the current invention;

FIG. 2 is a flow chart representing buying media resources;

FIG. 3 is another embodiment of a system used to implement the current invention; and

FIG. 4 is a flow diagram of a procedure for executing a mobile agent.

### DETAILED DESCRIPTION OF THE INVENTION

As illustrated in the background, the definition, implementation, tracking, and reconciliation phases of an ad campaign are complex and require a high degree of participation between the involved entities and their personnel. Additionally, the status of a ongoing campaign ad is difficult to determine without knowledge concerning which stage the campaign ad is currently in is available. For example, during the create job order phase of the profiling stage, vendors may be unaware that an ad campaign is being organized. The overall campaign may proceed more expeditiously if this information were available. Additionally, during the airing stage of the ad campaign the client may not have an indication as to existing discrepancies between the pre-spot schedule and the actual ads run by the vendor. The client would, of course, be informed of the discrepancy, immediately or at a later time. A need exists which will allow the status of a specific ad campaign to be identified quickly and accurately. Additionally, a need exists to automate the ad campaign process to be less user intensive and more automated. Additionally, a further need exists which will allow each of the entities involved in the overall ad campaign to exchange data, information, status, or other pertinent data easily and accurately without regeneration or repeatedly entering the information into the system.

The present invention automates all phases of ad campaigns including campaign creation, coordination, approval, placement approval, verification and accounting using a work flow technique in combination with mobile agent technology. Mobile agents provide substantial advantages over other means of providing for interaction and communications between parties to a transaction. As is understood by those skilled in the art, mobile agents physically travel across a network to perform tasks on machines that provide agent hosting capability. Using mobile agents provides for the migration from computer to computer of processes in an asynchronous fashion as required to formalize, approve, and implement an ad campaign. As used herein, asynchronous refers to an automatic container of data, logic, and/or presentation objects that is independent of a destination on target application to which the mobile agent is next sent. Unlike e-mail messages or remote procedure calls, where a process involves procedures of a remote host, process migration allows executable code to travel and interact with databases, file systems, information services and other agents. Thus, for example, rather than sending an e-mail to a potential media vendor requesting a response to an RFQ, a mobile agent might directly interact with the vendor's systems and databases to obtain the necessary information before reaching the user. In addition, the use of a mobile agent allows enhanced versatility of interaction, because the mobile agent dynamically adjusts to varying conditions. The mobile agent may visit multiple users to provide a preferred mix of information, dynamically readjusting as various requirements are satisfied or optimizing results by reacting to changing conditions. The mobile agent may also adjust for proprietary information. For example, proprietary information may be stripped or removed from a mobile agent before the mobile agent is sent to an outside entity. According to a preferred embodiment, the CONSILIENT platform includes TASKLETS acting as mobile agents. In this case, the TASKLETS are small, temporary sections of a website, specifically and dynamically created to support each stage and step of a method for buying media resources. Using JAVA technology and XML, the TASKLETS may support mobile agent technology. Alternatively, the TASKLETS may remain resident on a server platform (e.g., a DPX server) but provide for dynamic interaction with a remote client or personal peer platform.

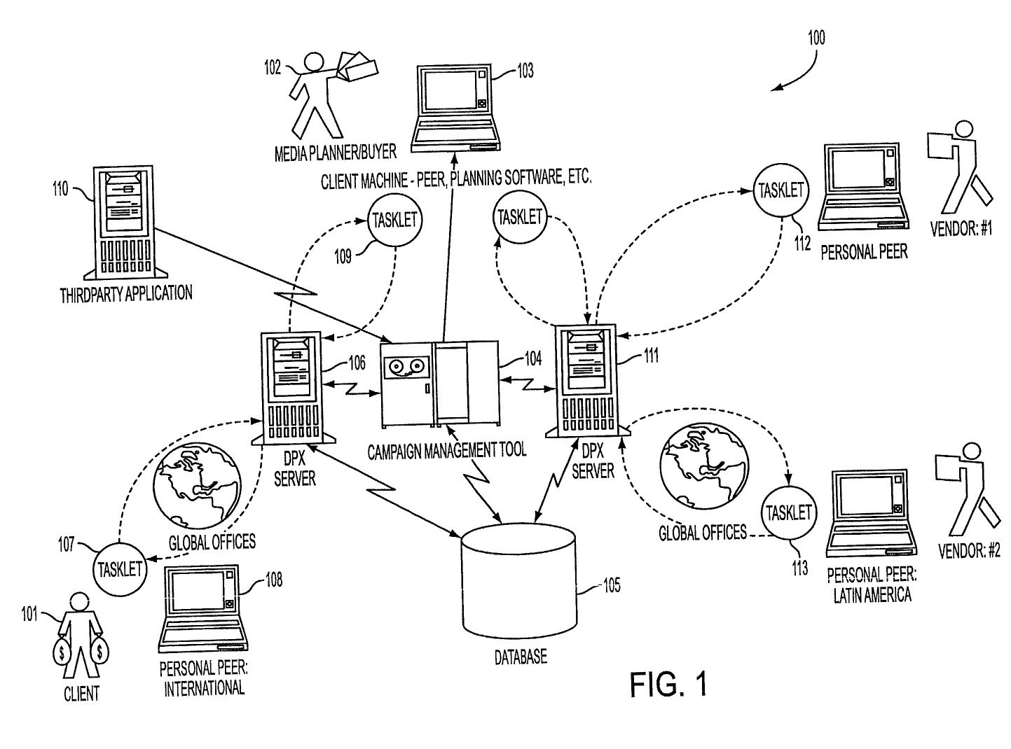

Referring to FIG. 1, campaign ad process 100 will be explained as one embodiment of the current invention. Client 101 contacts a media director to discuss a potential ad campaign. Media director 102 uses campaign management tool (CMT) software resident on the agency system 104 to create a job order. This job order is also kept in campaign management tool 104 which enters the job order into database 105. Campaign management tool 104 working with DPX server 106 uses the information contained in database 105 to create TASKLET 107, or another type of mobile agent, which client 101 views using personal peer machine 108. Client 101 may suggest changes to the job order created by media director 102 and may interact with media director 102 to update the job order. Once the job order is agreed to, client 101 approves TASKLET 107 and sends the approved TASKLET as a buy authorization form to DPX server 106. This accepts the proposed job order. In response, DPX server 106 updates database 105. DPX server 106 and 111 may be distributed across one or more machines in various configurations.

Media director 102 may desire research data to determine the effectiveness of the job order. In this case, media director 102, again using client machine 103, indicates to client management tool 104 that research data is desired. Research information, planning information, or similar information from third party application 110 is sent to campaign management tool 104 and stored in database 105. Media director 102 may then access, via client machine 103 and campaign management tool 104, the information contained in database 105 to update the proposed job order. Each of these steps take place during Stage 1, profiling, of the overall campaign ad process.

Once the proposed job order is finalized with the client, media director 102 analyzes the client's needs and assembles a group of potential vendors which may be able to fulfill those needs. Third party or built-in software may be used to assist in the planning of the campaign. Working with client machine 103, media director 102 indicates prospective vendors to campaign management tool 104 which, working with DPX server 111 creates TASKLETS or other mobile agents to be sent to proposed vendors. In FIG. 1, TASKLETS 112 and 113 are sent to proposed vendors, Vendor #1 and Vendor #2 respectively. These TASKLETS contain proposed guidelines or media preferences.

Vendors #1 and #2 review the respective TASKLETS 112 and 113 which may include media availability, price information, types of ads, ad placement, length of ads, etc. and use this information to determine prices and availability to be sent back to the CMT 104. TASKLETS 112 and 113 are updated by vendors #1 and #2 and returned, and are then processed to create a media campaign proposal by DPX server 111 working with campaign management tool 104. Note that the TASKLETS also support iterations to allow for negotiations between the media buyer and vendor. Using the information contained in TASKLETS 112 and 113, campaign management tool 104 creates a new TASKLET or mobile agent representing the media campaign proposal which is transmitted to client 101. Client 101 reviews the media campaign proposal contained in TASKLET and, possibly, after interaction with the media director, accepts the media campaign proposal to create a finalized contact which is sent back to DPX server 106, which works with campaign management tool 104 to generate a new TASKLET, representing media buy confirmations and which are sent to the selected vendors.

Once the media buy confirmations are sent to the selected vendors, the vendors prepare to run the associated ads. This may require no advance payment or payment by the client for a portion or all of the fees or costs. Selected vendors may also report the receipt of the media buy confirmation with a response and once the ads are run may return an ad run confirmation.

Ad run confirmation may also be accomplished by use of a TASKLET or mobile agent which may travel from media director to vendor site collecting information confirming ad placement. Further, the TASKLET may solicit information from independent verification sources including media monitoring agencies to confirm that all ads had been properly placed in run. Thus, for example, the confirmation TASKLET may be generated by campaign management tool 104 and DPX server 111 which is made available or sent to personal peer 112 and personal peer 113 to confirm ad placement and running. Although not shown, another TASKLET may be established or a mobile agent created to visit and interact with a third party media verification system which monitors the media utilized by the ad campaign.

As a result of the verification process, a discrepancy log may be created to identify variations from the approved media campaign proposal and further reflecting accounting adjustments to be made in view of such variations. Again, such functionality may be supported by TASKLET and/or mobile agents to support reconciliation. Thus, discrepancies between the post-spot schedule and the finalize pre-spot schedule are resolved and appropriate action is taken by the media director/buyer using appropriate TASKLETS and/or mobile agents.

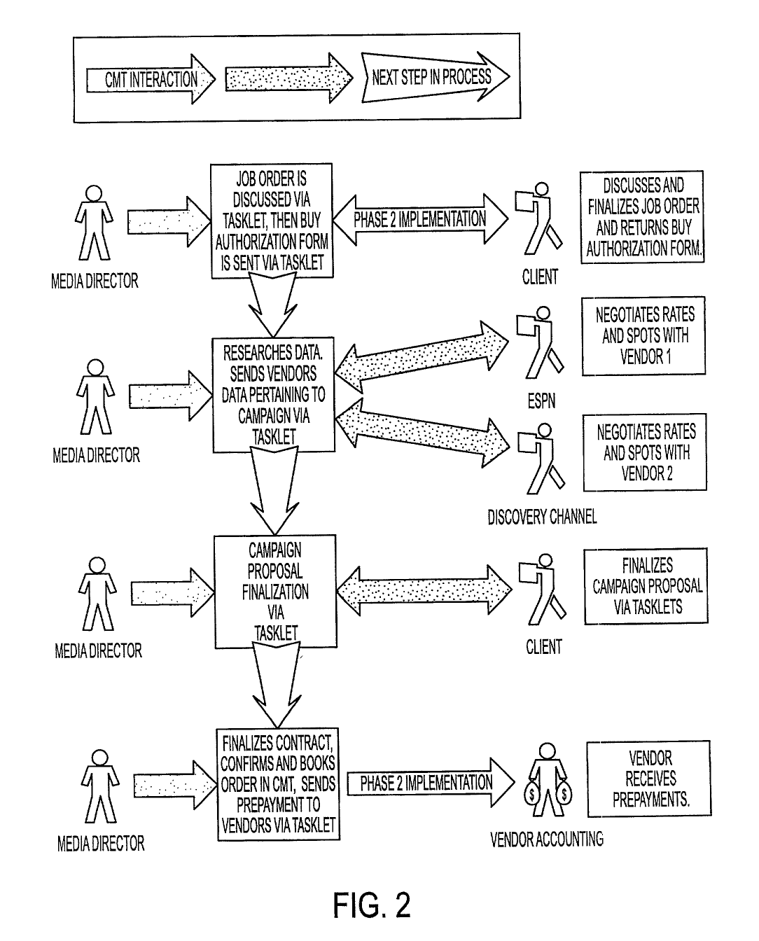

FIG. 2 shows the flow of steps required to implement a media buying process supported by the invention. Initially, a media director discusses and finalizes a job order with a client so that the client can, via a TASKLET, return a buy authorization form resulting in a buy order authorization form creation. Once the buy authorization form is created, the media director can negotiate rates and spots with vendors 1 and 2, again via a TASKLET and/or mobile agent that in particular, the media director may research data in response to the authorization form and send the vendor's data pertaining to the campaign via the TASKLET. Again, the vendors respond using the TASKLET so that a campaign proposal is finalized with the client and media director. Once finalized, if the contract allows confirmation and booking of orders placed with the vendors and any advance or pre-payments are sent to the vendors via an appropriate TASKLET. For example, the TASKLET may include payment information so that the vendor can receive pre-payments allowing them to place and run the requested spots.

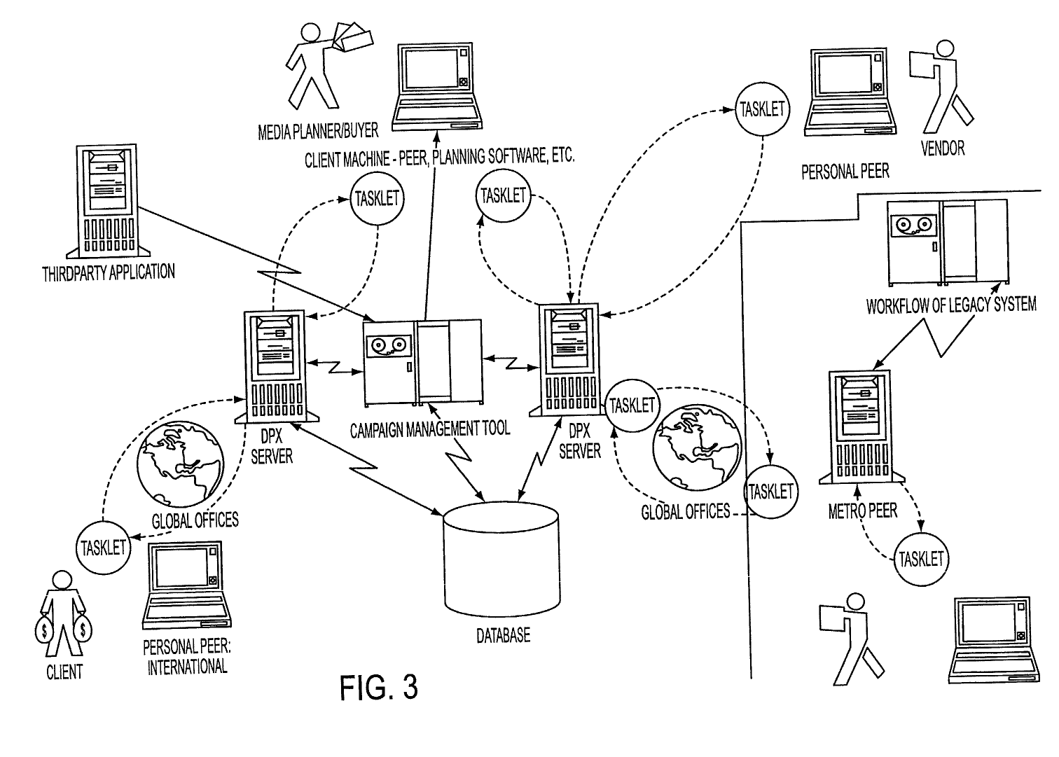

FIG. 3 shows an alternate embodiment of the invention in which a vendor, instead of having a personal peer, includes a DPX server. Thus, instead of the vendor accepting a TASKLET and interacting directly with that TASKLET as provided by the campaign management tool and DPX server, the vendor maintains its own DPX server behind its firewall, interacting with internally generated TASKLETS to review and accept orders. Note that TASKLETS are still used to interact between the campaign management tool DPX server and the DPX server of the vendor.

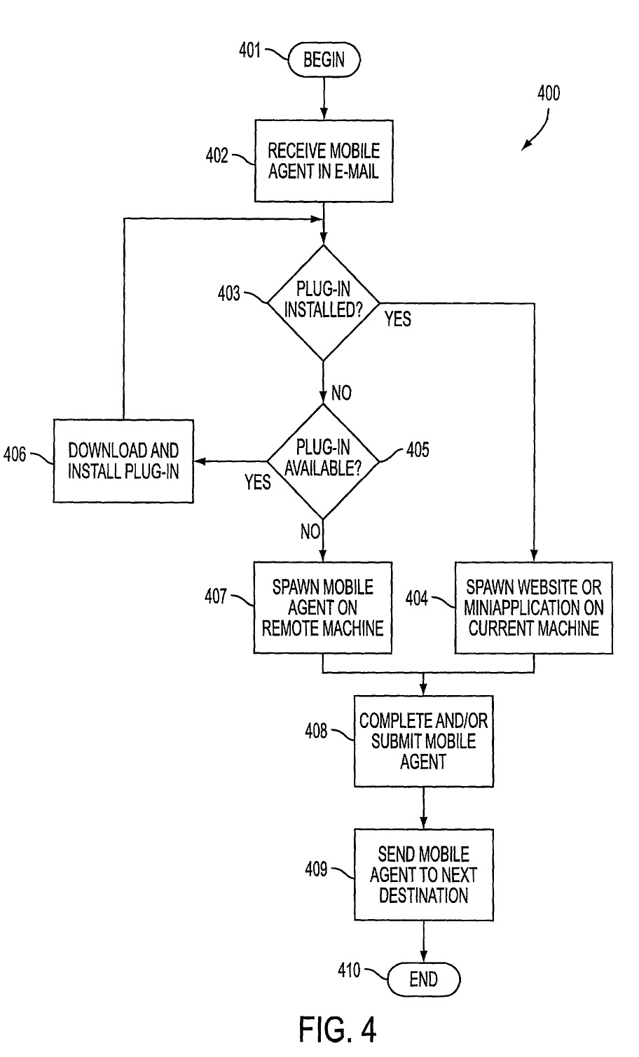

FIG. 4 is a flow diagram of a procedure for executing a mobile agent. After entering the procedure at step 401, a mobile agent is received at step 402, preferably as an attachment or otherwise associated with an e-mail message. The e-mail may use conventional protocols including, for example, Simple Mail Transfer Protocol (SMTP) and related standards for host-to-host mail transfers, POP and IMAP for client-to-host communication, RFC822 defining basic message format and encoding, and Multipurpose Internet Mail Extensions (MIME). By designating an appropriate Application Media Type in the MIME, the mail client on the current machine can identify the appropriate plug-in required to support the mobile agent and provide for its execution. Thus, at decision 403 a test is performed to check to see if the required plug-in is properly installed and available on the current machine. If installed, processing continues at step 404 to spawn a website defined by the mobile agent on the current machine using the plug-in.

If the test at decision 403 is failed, indicating that the plug-in required to execute or otherwise support the mobile agent is not installed, then flow continues at decision 405 where a test is performed to determined if the plug-in is available, either locally or by download from a server or peer. If available, an attempt is made to obtain and install the plug-in at step 406 after which flow continues back at decision 403 to test for proper installation of the plug-in. Alternatively, if the required plug-in (or other helper application or tool) is not available, processing continues at step 407 to spawn the mobile agent on some remote machine such as a remote server. In this case, the current machine may access the server running the mobile agent remotely using, for example, a web browser.

Once the mobile agent is spawned, either locally on the current machine (step 404) or remotely on a remote server or peer (step 407), processing continues at step 408 wherein the current machine is used to complete and/or submit the mobile agent. Step 408 may be performed automatically by execution of the mobile agent in concert with any local applications with which the mobile agent is permitted to interface, require manual user input and/or intervention, or some combination of autonomous and manual actions. Once completed, the mobile agent is sent on to the next destination at step 409 and the procedure terminates at 410.

While the foregoing has described what are considered to be preferred embodiments of the invention, it is understood that various modifications may be made therein and that the invention may be implemented in various forms and embodiments, and that it may be applied in numerous applications, only some of which have been described herein. It is intended by the following claims to claim all such modifications and variations which fall within the true scope of the invention. Note that while the invention has been described as using a consilient platform, other platforms such as adobe, acrobat, zaplet and similar platforms may be used without varying from the scope of the invention.

It should further be noted and understood that all publications, patents and patent applications mentioned in this specification are indicative of the level of skill of those skilled in the art to which the invention pertains. All publications, patents and patent applications are herein incorporated by reference to the same extent as if each individual publication patent or patent application was specifically and individually indicated to be incorporated by reference in its entirety.

What is claimed is:

1. A method of buying media resources for an advertising campaign comprising the steps of:
transmitting a first mobile agent with a media availability query to a potential vendor;
receiving, via said first mobile agent, media availability from said potential vendor;
processing said first mobile agent to create a media buy confirmation and, in response, creating a second mobile agent representing said media buy confirmation; and
transmitting said second mobile agent representing said media buy confirmation to said potential vendor.

2. The method of claim 1 further comprising the steps of:
receiving, via said second mobile agent, buy confirmation from said potential vendor.

3. The method of claim 1 further comprising the steps of:
generating a buy authorization including a first level of detail characterizing said advertising campaign;
accepting, via a third mobile agent, said buy authorization;
processing said third mobile agent, and
identifying potential vendors and, in response, generating said first mobile agent containing said media availability query to said potential vendor.

4. The method of claim 3 further comprising the steps of:
generating a media campaign proposal and, in response, creating a fourth mobile agent representing said media campaign proposal;
transmitting said fourth mobile agent representing said media campaign proposal to said client;
accepting, a fifth mobile agent, client approval of said media campaign; and
processing said fifth mobile agent to include information contained in said media campaign in said media buy confirmation.

5. The method of claim 1 further comprising the steps of:
returning a sixth mobile agent representing an add run confirmation;
processing said sixth mobile agent to create a postlog entry and, in response, creating a discrepancy notification.

6. The method of claim 5 further comprising the steps of:
creating a seventh mobile agent requesting a third party add run confirmation;
transmitting said seventh mobile agent representing said third party add run confirmation request to said third party; and
returning said seventh mobile agent representing third-party add run confirmation.

7. The method of claim 1 wherein said step of accepting includes a step of modifying data contained in said job order.

8. The method of claim 1 wherein one of said steps of transmitting includes receipt of a corresponding one of said mobile agent and in response, automatic retrieval of data from a database in fulfillment of data requested by said corresponding one of said mobile agent.

9. The method of claim 1 further comprising the step of:
maintaining a database recording a state of each of said mobile agents.

10. The method of claim 1 further comprising the step of:
reformatting data contained in at least one of said mobile agents to interface with a computer system used by an intended recipient of said at least one of said mobile agent.

11. A computer system configured to perform the following steps:
transmitting a first mobile agent with a media availability query to a potential vendor;
receiving, via said first mobile agent, media availability from said potential vendor;
processing said first mobile agent to create a media buy confirmation and, in response, creating a second mobile agent representing said media buy confirmation; and
transmitting said second mobile agent representing said media buy confirmation to said potential vendor.

12. The computer system of claim 11 further configured to perform the follow step:
receiving, via said second mobile agent, buy confirmation from said potential vendor.

13. The computer system of claim 8 further configured to perform the following steps:
generating a buy authorization including a first level of detail characterizing said advertising campaign;
accepting, via a third mobile agent, said buy authorization;
processing said third mobile agent; and
identifying potential vendors and, in response, generating said first mobile agent containing said media availability query to said potential vendor.

14. The computer system of claim 13 further configured to perform the following steps:
generating a media campaign proposal and, in response creating a fourth mobile agent representing said media campaign proposal;
transmitting said fourth mobile agent representing said media campaign proposal to said client;
accepting, via a fifth mobile agent, client approval of said media campaign; and
processing said fifth mobile agent to include information contained in said media campaign in said media buy confirmation.

15. The computer system of claim 11 further configured to perform the steps of:
returning a sixth mobile agent representing add run confirmation;
processing said sixth mobile agent to create a postlog entry and, in response, creating a final discrepancy notification.

16. The computer system of claim 15 further configured to perform the steps of:
creating a seventh mobile agent requesting a third party add run confirmation;
transmitting said seventh mobile agent representing said third party add run confirmation request to said third party; and
returning said seventh mobile agent representing third-party add run confirmation.

17. The computer system of claim 11 wherein said step of accepting includes a step of modifying data contained in said job order.

18. The computer system of claim 11 wherein one of said steps of transmitting includes receipt of a corresponding one of said mobile agent and in response, automatic retrieval of data from a database in fulfillment of data requested by said corresponding one of said mobile agent.

19. The computer system of claim 11 further configured to perform the step of:
maintaining a database recording a state of each of said mobile agents.

20. A computer program contained on a computer readable media configured to perform the steps of:
transmitting a first mobile agent with a media availability query to a potential vendor;
receiving, via said first mobile agent, media availability from said potential vendor;
processing said first mobile agent to create a media buy confirmation and, in response, creating a second mobile agent representing said media buy confirmation; and
transmitting said second mobile agent representing said media buy confirmation to said potential vendor.

21. The computer program of claim 20 further configured to perform the steps of:
generating a buy authorization including a first level of detail characterizing said advertising campaign;
accepting, via a third mobile agent said buy authorization;
processing said third mobile agent; and identifying potential vendors and, in response, generating said first mobile agent containing said media availability query to said potential vendor.

22. The computer program of claim 20 further configured to perform the steps of:
generating a media campaign proposal and, in response creating a fourth mobile agent representing said media campaign proposal;
transmitting said fourth mobile agent representing said media campaign proposal to said client;
accepting, via a fifth mobile agent, client approval of said media campaign; and
processing said fifth mobile agent to include information contained in said media campaign in said media buy confirmation.
